(19) United States
(12) Patent Application Publication
(10) Pub. No.: US 2017/0318446 A1
(43) Pub. Date: Nov. 2, 2017

(54) EMERGENCY REPORTING DEVICE AND METHOD

(71) Applicant: Hangyul LEE, Seoul (KR)

(72) Inventor: Hangyul LEE, Seoul (KR)

(21) Appl. No.: 15/204,053

(22) Filed: Jul. 7, 2016

(30) Foreign Application Priority Data
Apr. 29, 2016 (KR) 10-2016-0052912

(51) Int. Cl. H04W 4/22; H04W 4/02

(52) U.S. Cl. CPC H04W 4/22; H04W 4/02

(57) ABSTRACT

An emergency reporting device comprises a location detecting unit configured to detect a current location of the device; a message generating unit configured to generate an emergency reporting message to indicate an emergency in an event of the emergency; a translating unit configured to determine a transmission language of the message based on the detected location, and to translate the message to a version of the determined language; and a transmission management unit configured to select an emergency reporting contact number based on the detected location and to transmit the version of the determined language using the selected emergency reporting contact number.

### BACKGROUND

### Field of the Present Disclosure

This invention relates to an emergency reporting device and method based on a detected location of an emergency event.

### Discussion of the Related Art

It is offered actions for emergency at national level to save a life securely and to reduce loss of property from all sort of emergency such as accidents, fire and disasters. The United States, for example, serves PSAP Public Safety Answering Point service which to call 911 for emergency situation and Republic of Korea provides emergency service to call a fire emergency dialing 119.

The reporting dial numbers using for this situations are established differently in each nation. For instance, Korea is 119, whereas the USA is 911, Japan and China are 110 and France sets up 17 for emergency dial number. Therefore, it has problems that users should checked the emergency reporting contact number in advance or ask others in case of having emergency situation and it is hard to ask for a help when you do not know the emergency reporting contact number on the emergency situation.

Also, due to the different languages using in the emergency situation in every country, it is difficult to notify the emergency properly if the person is not fluent in the language of the country even though the call is connected to the responder agency.

Especially, for the action in emergency situation, it is very important to be informed of what the situation is and the location of the occurrence to rescue people who are in the emergency rapidly and securely as well as getting the personal information such as the illness, blood type, age, disability, address of the user for the proper actions in the emergency situation. However, if the user is not fluent in the language of the country or the person is unconscious, it would be hard to get that information.

Prior art document: Korea patent publication NO. 10-2009-0085402 “Overseas emergency rescue support system and its method for using user's personal information” published in 7 Aug. 2009

### SUMMARY

This invention has the purpose to provide the device and the method for informing the emergency by determining the language and dial number for reporting automatically based on the location of the occurrence of the situation to resolve the issues mentioning before.

In an aspect of the present disclosure, there is provided an emergency reporting device comprising: a location detecting unit configured to detect a current location of the device; a message generating unit configured to generate an emergency reporting message to indicate an emergency in an event of the emergency; a translating unit configured to determine a transmission language of the message based on the detected location, and to translate the message to a version of the determined language; and a transmission management unit configured to select an emergency reporting contact number based on the detected location and to transmit the version of the determined language using the selected emergency reporting contact number.

In one embodiment, the determined language corresponds to the most frequently language in the detected location, wherein the determination is directly executed by the device or is indirectly executed by the device via an emergency management server communicating with the device.

In one embodiment, the emergency reporting message includes at least one of the detected location, a pre-stored personal information of a user of the device, and a pre-stored emergency reporting contact number.

In one embodiment, the transmission management unit is further configured to determine whether a text message is able to be sent using the emergency reporting contact number, and, upon determination that the text message is not able to be sent using the emergency reporting contact number, to trigger a voice call using the emergency reporting contact number.

In one embodiment, the transmission management unit is further configured to transmit the version of the determined language to a preset emergency management server or a destination corresponding to a preset contact number.

In an aspect of the present disclosure, there is provided an emergency reporting method comprising: detecting a current location of a user based on a mobile device of the user; generating an emergency reporting message to indicate an emergency in an event of the emergency; determining a transmission language of the message based on the detected location; translating the message to a version of the determined language; selecting an emergency reporting contact number based on the detected location; and transmitting the version of the determined language using the selected emergency reporting contact number.

In accordance with the present invention, it is expected to increase the efficiency of informing the emergency by generating the reporting message automatically and translating the message into the local language of the emergency location.

### BRIEF DESCRIPTIONS OF THE DRAWINGS

The accompanying drawings included to provide a further understanding of the present disclosure illustrate embodiments of the present disclosure.

FIG. 1 shows emergency reporting system roughly according to the embodiment.

FIG. 2 shows a block diagram to explain the device of informing the emergency on FIG. 1.

FIG. 3 shows an example of an interface to input the personal information.

FIG. 4 shows an example of an interface to input the emergency.

FIG. 5 shows another example of an interface to input the emergency situation.

FIG. 6 shows one example of an emergency reporting message.

FIG. 7 shows one example of an emergency reporting contact number based on a detected location.

FIG. 8 shows a flow chart to describe a method of informing emergency according to the embodiment.

FIG. 9 explains a step of generating the reporting message from FIG. 8.

### DETAILED DESCRIPTIONS

Examples of various embodiments are illustrated in the accompanying drawings and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

Example embodiments will be described in more detail with reference to the accompanying drawings. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “connected to”, or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, s, operations, elements, and/or components, but do not preclude the presence or addition of one or more other features, integers, s, operations, elements, components, and/or portions thereof. As used herein, the term “and/or” includes any and all combinations of one or more of the associated listed items. Expression such as “at least one of” when preceding a list of elements may modify the entire list of elements and may not modify the individual elements of the list.

Spatially relative terms, such as “beneath,” “below,” “lower,” “under,” “above,” “upper,” and the like, may be used herein for ease of explanation to describe one element or feature's relationship to another element s or feature s as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented for example, rotated 90 degrees or at other orientations, and the spatially relative descriptors used herein should be interpreted accordingly.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the following description, numerous specific details are set forth in order to provide a thorough understanding of the present disclosure. The present disclosure may be practiced without some or all of these specific details. In other instances, well-known process structures and/or processes have not been described in detail in order not to unnecessarily obscure the present disclosure.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present disclosure refers to “one or more embodiments of the present disclosure.

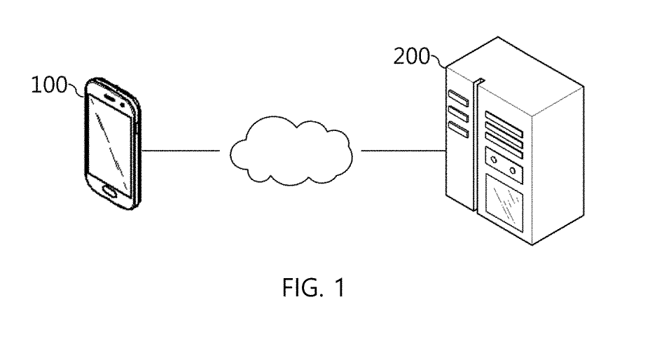

FIG. 1 shows emergency reporting system 10 roughly according to the embodiments.

Referring to the FIG. 1, the emergency reporting system 10 includes an emergency reporting device 100 and an emergency management server 200 to supervise the multiple emergency reporting devices 100.

The management server 200 is connected to the emergency reporting device 200 through a network to transfer the application which is necessary to operate the device. Also, it provides registered information after researching by the request of the emergency reporting device 100 and receives the reporting message from the device 100 for storing the message.

In this regard, the reporting message means the information about the emergency of a user or the emergency witnessed by the user and it contains at least one of information from the status consisting of emergency information or the emergency contact number registered in advance.

The emergency reporting device 100 can generate the reporting message according to the emergency situation and create the translated message based on the location of the occurrence and then transfer the translated message to the emergency reporting contact number.

In here, the emergency reporting contact number is the contact number to get in touch with the responder agencies to provide emergency service such as fire station, police station and emergency medical service and the translated message means that the reporting message is rendered into specific language.

The emergency reporting device 100 can be a smartphone as shows in the figure, but it can be any devices which are potable and easily communicated with other devices such as PMP Portable Media Player, PDA Personal Digital Assistant and tablet PC.

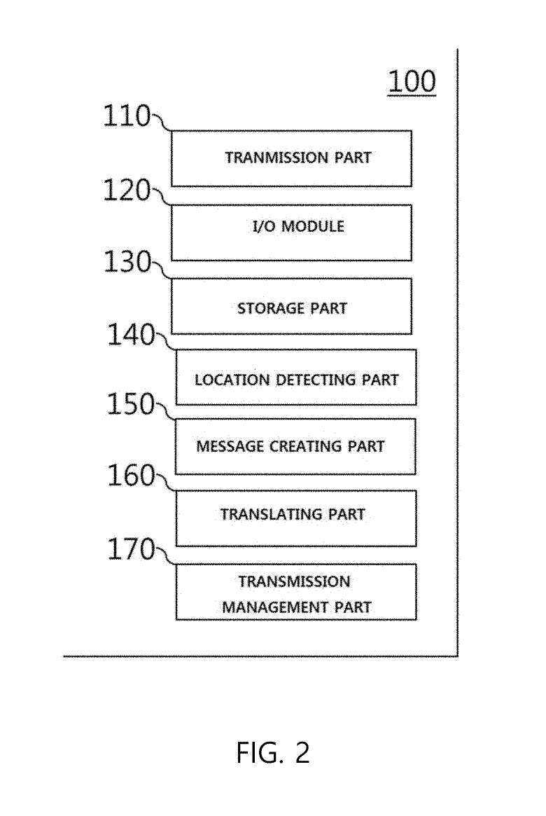

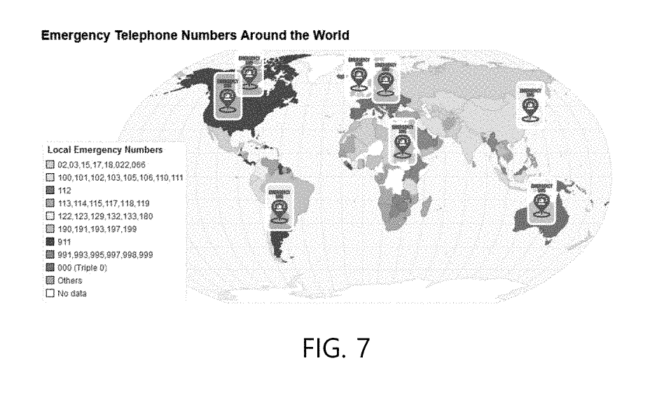

Below is to explain in details of emergency reporting device 100 by referring to FIG. 2 or FIG. 7.

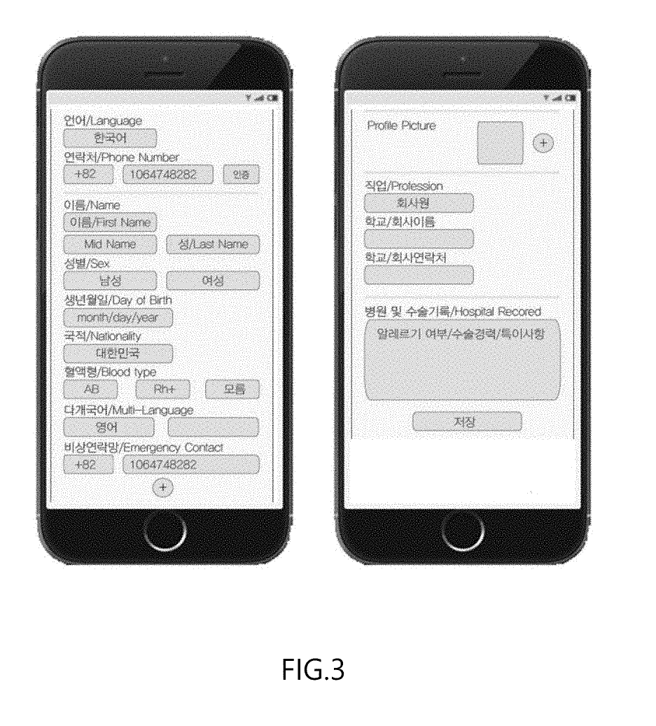

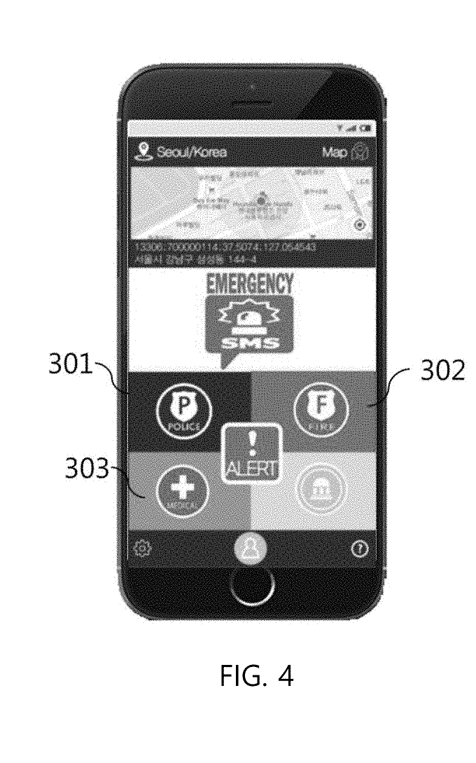

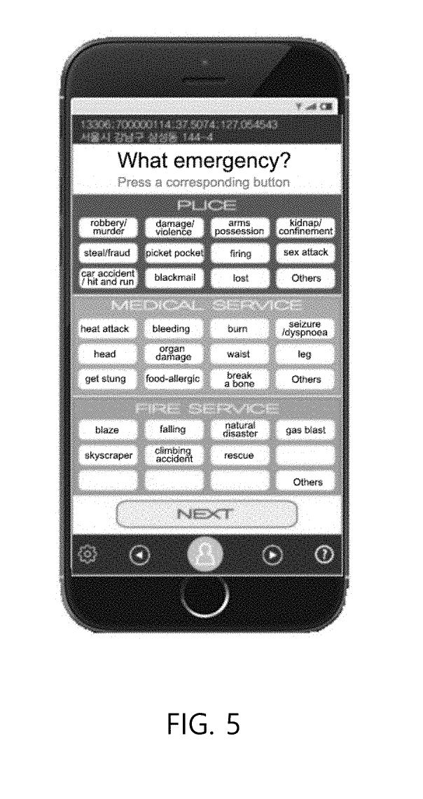

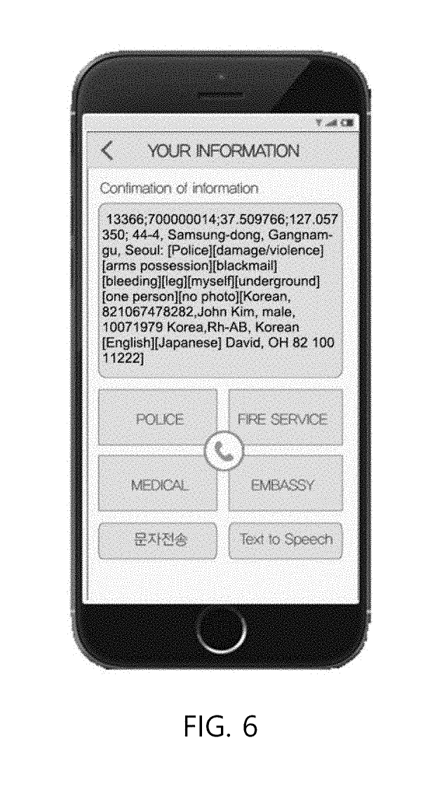

FIG. 2 is the control block to describe the emergency reporting device 100 and FIG. 3 shows the case of interface to input personal information. Also, the FIG. 4 represents the case of interface to input the emergency situation and FIG. 5 is for other cases of interface to input the emergency situation. FIG. 6 shows the examples of the reporting message and FIG. 7 indicates the emergency reporting contact number by region.

Referring to the FIG. 2, the emergency reporting device 100 includes transmission unit 110, I/O module input/output module 120, storage unit 130, location detecting unit 140, message generating unit 150, translating unit 160 and transmission management unit 170.

The transmission unit 110 is connected to a network to transmit and receive data with a management server and transfer the reporting message to the responder agencies.

The transmission unit 110 can be connected to the network through a series of GSM/3GPP communication system GSM, HSDPA, LTE Advanced or a unit of 3GPP2 communication system CDMA or air-interface protocol such as wiMAX as well as it is connected to the conventional communication system or a new communication protocol depending on the technical development later.

I/O module 120 indicates information for users to read or shows interface for registering information. Specifically, I/O Module 120 can represent an interface to get personal information from users as shown in FIG. 3 and to get emergency information as shown in FIG. 4 or 5 and to check the reporting message as shown in FIG. 6.

Also, the I/O Module 120 is available to show the location around the device by registration of users and display routes to the responder agency from the current location. With this I/O Module 120 is consist of the indicators such as Plasma Display Panel PDP, Liquid Crystal Display LCD, Light Emitting Diode LED, Organic Light Emitting Diode OLED, Active-matrix Organic Light-Emitting Diode AMOLED

Furthermore, it has pushbutton input device such as a push button or membrane button or touch input device such as touch pad and it can be implemented by touch screen formation with both input and output function.

Storage unit 130 is for storing necessary date for the operation of the devices. For example, the storage unit 130 has operating system to run the device for informing emergency 100 and location detecting unit 140 which will be described later and message generating unit 150, translating unit 160 and an application to operate transmission management unit 170.

In addition, the storage unit 130 is possible to save personal information registered by users. For instance, the storage unit 130 can save personal information such as the first language of the user, contact number, name, gender, date of birth, nationality, blood type, a list of available language, occupation and medical records as well as one of emergency contact numbers.

Also, the storage unit 130 contains high-speed random access memory, SRAM, DRAM, ROM, but it is not limited only for this.

Furthermore, the storage unit 130 and location detecting unit 140 are removable to the emergency reporting device 100. For instance, the storage unit 130 and the location detecting unit 140 include Compact flash card, Secure Digital card, Smart Media card, Multimedia card or memory stick, but it is not limited only for this.

The location detecting unit 140 detects the location of an emergency reporting device 100. For the example of the implementation, the location detecting unit 140 analyses the coordinate for the location from the emergency reporting device 100 based on the signal transmitted from the GPS satellite and retrieves the location of the device 100.

From another implementation, the location detecting unit 140 can retrieve the location of device 100 by communication with a WI-FI repeater which is connected to a cell tower of carrier. To put it concretely, the location detecting unit 140 can retrieve the country with the emergency reporting device 100 based on the information of the carriers which are communicated with the transmission unit 110 or analyze the time of communication with several cell towers of carrier for retrieving the location of emergency reporting device 100. Also, it traces the IP address of adherent WI-FI devices for checking the location of the device 100 by using the IP address.

Meanwhile, the method of detecting the location as described above is a typical embodiment to retrieve the location from the detecting location unit 140 and the unit 140 can be by using the existing method for detecting the location or a new method after the development of technology later.

The message generating unit 150 generates the reporting message for requesting the emergency service by sending the information of emergency situation to the responder agencies when it happens.

For the more detail, the message generating unit 150 can detect the emergency situation. The emergency can be detected by the registration of users. For the example of the implementation, the emergency situation can be registered by selecting an icon which is included in the interface as shown in FIG. 4. At this time, the user can select the types of emergency by choosing the icon indicated in the interface. The interface contains icon no. 1 301 for registering the emergency about crime and icon no. 2 302 for disaster and icon no. 3 303 for emergency about first-aid.

The types of emergency which is selectable by user interface can be more various as needed and the more detailed reporting message for situational information to responder agencies can be transferred by expanding the range of selection for emergency situation.

For example, the user interface is formed to be able to select more specified situation by crime, disaster, first-aid emergency as shown in FIG. 5.

When the emergency is detected, the message generating unit 150 generates the reporting message corresponding with the emergency situation. At this time, the reporting message contains the information about the emergency situation. The information can be registered in advance. Specifically, the situation information can be registered in the storage unit 130 by the selection of emergency type from the user in advance through the user interface and the message generating unit 150 can generate the reporting message to contain the situation information corresponding with the selected emergency by the user. For example, when the user selects the icon no. 2 302, it retrieves the situation information for the emergency about fire and creates the reporting message containing the retrieved information. Also, the message generating unit 150 can generate a reporting message including at least one of information among personal information, contact number or location detected from the location detecting unit 140.

As it is described, users can register their personal information by using the emergency reporting device 100. Thus, the registered personal information can be stored in the storage unit 130 or saved in the management device through transmission unit 110.

To take proper emergency measures, it is necessary to have user's personal information. Therefore, the message generating unit 150 can make inquiry about personal information such as the first language of the user, contact number, name, gender, the date of birth, nationality, the blood type, the available language, the emergency contact, occupation and the medical record as well as generating reporting messages with the personal information. In case that the user is injured, the reporting message is generated with containing personal information such as the user's blood type and the medical records. By generating this reporting message containing those personal information, the efficiency of response for the related agencies. Also, the reporting message can contain the contact information registered in advance. For instance, the reporting message is created by having the information of emergency contact number registered by users along with the personal information or the contact number of the embassy where the user is residence. By generating the reporting message with the emergency contact number, the responder agencies can easily get in touch with protectors or protect authorities.

Moreover, the reporting message embodies the information of location. For taking proper action by the responder agency, it is very important to figure out the location of the occurrence for the emergency. Therefore, the reporting message unit 150 should create the message with the location from detecting unit 140. At this point, the information of the location can be the GPS coordinate, but it is not limited for this. The location information can be generated by retrieving the address corresponding with the GPS coordinate.

Furthermore, the message generating unit 150 is registered whether the emergency is happened to the user or is witnessed by the user and it generates the reporting message including this information.

At this time, the information in the message can be different depending on whether the emergency is happened to the user or is witnessed by the user. For instance, if the user witnessed the emergency, the reporting message will be created only with location and the situation information and if the user is in the emergency, the message will contain his/her personal information and the contact number.

Also, the message generating unit 150 can include images or video file. The image or video file can be saved in the emergency reporting device 100 in advance or they can be filmed on the spot.

The reporting message created with this process can be transferred to the responder agency after confirming the message indicating with I/O module 120 by the user. Specifically, the message generating unit 150 can present a reporting message containing location, situation, personal information, and the emergency contact number as shown in FIG. 6 by controlling I/O module 120 and it can transmit the reporting message as the user input. However, the transmission of the reporting message can be performed without the user's input as needed and the completion of the transmission is indicated as well as the reporting message.

The translating unit 160 creates a message after translating the reporting message. The message is called “the translated message. The language which is used in responder agencies is vary depending on the nations or regions and the translating unit 160 determines a language for corresponding with the location of the occurrence retrieved from the location detecting unit 140 for transferring the reporting message and translates the reporting message. For example, if the location information matches with USA, then English will be selected as the transferring language and be translated the reporting message. Also, if the location is in France, French will be selected. The regional language information can be registered in the storage unit 130 as well as be looked up the information through management server 200. For instance, the translating unit 160 transfers the location information to the management server 200 and it is possible to make inquiries on the language which is used in the region corresponding with the location information.

The translating unit 106 translates the reporting message in the transferring language. An application or a library for translating can be saved in the storage unit 130 and the translating unit 130 creates the translating message by using the date in the storage unit 130.

Also, the translating unit 160 can request a translation to the management device for special language. It is happened to fail the translation in the device of informing the emergency 100 due to capacity limits in the storage unit 130, so the translating unit 160 can verify the availability of translation itself and request for help to the management server 200 after transferring the reporting message if it is not possible for translating. The management server 200 translates the reporting message as requested and transmits the message to the emergency reporting device 100. As the translating unit 160 performs its function interworking with the management server 200, the efficiency of the translation for the reporting message is increased.

In addition, the translating unit 160 can translate the message in multiple languages. As the several languages are spoken in Switzerland, the translating unit 160 selects multiple languages for transfer and creates several messages after translating into each language

The transmission management unit 170 transfers the translated message to responder agencies. As shown in FIG. 7, the emergency reporting contact numbers are varying depending on nations or regions. For example, the emergency reporting contact number in the USA and Canada is 911, and in Australia is 106. Also, there are regions to operate with one emergency reporting contact number as in the USA, but other regions have different emergency reporting contact numbers depending on the types of the emergencies. For domestic case, 119 are for disaster or rescue and 112 is related in crimes. As the emergency reporting contact number is different depending on the types of emergency, the transmission management unit 170 can analyze the types of emergency based on the situation information contained in the reporting message and retrieve the emergency reporting contact number corresponding with the situation.

The national or regional emergency reporting contact number can be registered in the storage unit 130, but it is not limited on this. For instance, the transmission management unit 170 can transfer the location information to the management server 200 for inquiring on the emergency reporting contact number. Once the emergency reporting contact number is chosen to transfer the translated message, the transmission management unit 170 can determine the method of the transfer. Specifically, the transmission management unit 170 makes the inquiry on at least one method to transfer the message to the emergency reporting contact number and determines the method of transmission based on the pre-set priority order.

For example, there are connecting call system in the USA, Canada, Europe, Australia and Korea as well as SMS. In case of using SMS for emergency situation, it is possible to contain a lot of information in less time than the collecting call. Therefore, the method of transmission by SMS is the priority. In detail, the transmission management unit 170 analyzes whether the emergency reporting contact number supports the SMS service and if it does, transfers the translated message. On the contrary, if the number is not possible to send the message, the transmission management unit 10 makes the connecting call to the emergency reporting contact number for transferring the message after converting it into a voice message to the responder agency. A developed TTS technology can be applied on the conversion of the translated message as the existed TTS Text to speech and new technology are improved.

Moreover, the transmission management 170 can transmit the reporting message or the translated message, which are transferred to the responder agency, to the management server 100. The transmission management unit 170 can control the emergency occurrence of users by transferring the messages to the management server 200.

Also, the transmission management unit 170 can transfer the messages to the responder agency by a pre-set device. For the example of the implementation, the transmission management unit 170 transfers the message with personal information to the responder agency. At this point, both reporting and the translated message can be transmitted.

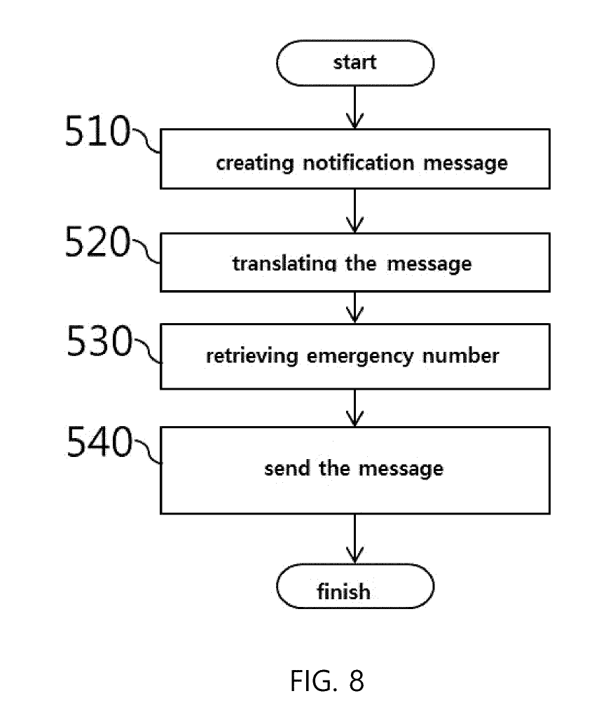

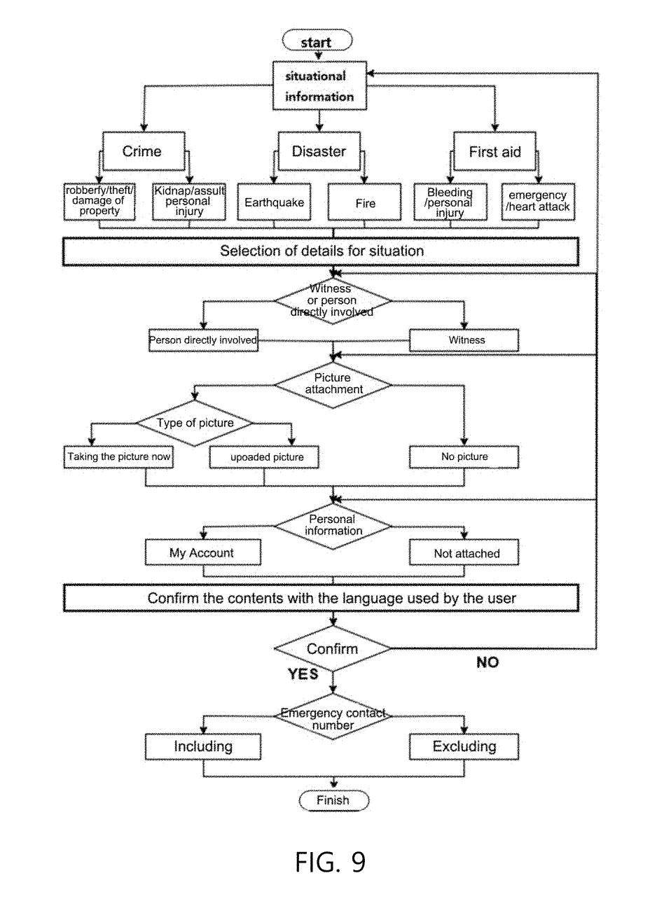

For other example of implementation, the transmission management unit 170 can be functioned to send messages to the registered contact numbers. At this point, the registered contact numbers can the one for the embassy, which the user is in residence. Specifically, the transmission management unit 170 searches the nation where the user is in based on the location information and sends the message to the contact numbers of the verified embassy. FIG. 8 is the flow chart to describe the method of informing the emergency according to the implementation and the FIG. 9 is for the details to indicate the stage of generating the reporting message from FIG. 8.

As referring to the FIG. 8, the emergency reporting device 100 creates the reporting message. For the details, a user notifies the emergency on it, a reporting message is generated. At this point, the reporting message contains situational information, personal information, emergency reporting contact number and locational information. The locational information can be retrieved from the GPS signal, but it is not limited on this. Also, the locational information can be collected on the occurrence of emergency, but it is not limited on this. For instance, the locational information can be collected in a row at the occurrence of emergency or at the interval specified in advance, and the locational information which is collected in the closest time of reporting for the emergency can be contained in the reporting message in case that the message is collected in a row. The reporting message can be generated in order as shown in FIG. 9. Specifically, the emergency reporting device 100 can create the situational information by the user's registration. The situational information can be classified into crime, disaster and the first aid and each situation can be classified in more details. For example the crime can be sorted into robbery/theft/damage of property and personal injury such as kidnap/assault. Disaster is classified into quake and fire and the first aid can be the personal injury such as bleeding or heart attach for emergency situation. This situational information relating to the detailed emergency can be registered in advance as it is described above. Therefore, the emergency reporting device can retrieve the registered situational information corresponding with the information which a user notifies and determines which situational information can be contained in the reporting message.

As the situational information is selected through this, the emergency reporting device 100 can measure if the user is the person who directly involved or is a witness and attaches a photograph as needed to the reporting message. Also, the emergency reporting device 100 can decide whether it includes personal information or not. Including the personal information can be determined as the type of emergency or whether the user is the person who involved directly or is a witness. The reporting message generated through this process can be transmitted after the confirmation of the user and the message can include the emergency contact number by the choice of the user.

The described FIG. 9 indicates the example of the reporting message and it is necessary to understand that the order of generating all of information in the reporting can be changed and some specific process can be omitted.

The emergency reporting device 100 creates the translated message 520. The translated message is created by the translation of the reporting. Specifically, the device 100 determines the language of the region corresponding with the locational information and translates the message with the language for generating the translated message. At this point, the translation is performed by using the application or library saved in the storage unit 130, but it is not limited on it. The translation can be operated with the management device as explained before. Also the message can be translated into multiple languages.

The emergency reporting device 100 retrieve the emergency reporting contact number 530. It analyzes the type of emergency based on the situational information in the reporting message and search the emergency reporting contact number based on the locational or emergency information.

The emergency reporting device 100 transfers the translated message to the emergency reporting contact number 540. It makes an inquiry on at least one method of transmission the translated message to the emergency reporting contact number and determines the method based on the pre-set priority. For instance, it determines whether sending SMS is available to the emergency reporting contact number or not. If it is not available, the collecting call is connected after converting the message to a voice message.

At this point, the message can be transferred to the management server 100 as well and it can be sent to the emergency contact number or the local embassy optionally.

The above description is not to be taken in a limiting sense, but is made merely for the purpose of describing the general principles of exemplary embodiments, and many additional embodiments of this disclosure are possible. It is understood that no limitation of the scope of the disclosure is thereby intended. The scope of the disclosure should be determined with reference to the Claims. Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

What is claimed is:

1. An emergency reporting device comprising:
a location detecting unit configured to detect a current location of the device;
a message generating unit configured to generate an emergency reporting message to indicate an emergency in an event of the emergency;
a translating unit configured to determine a transmission language of the message based on the detected location, and to translate the message to a version of the determined language; and
a transmission management unit configured to select an emergency reporting contact number based on the detected location and to transmit the version of the determined language using the selected emergency reporting contact number.

2. The device of claim 1, wherein the determined language corresponds to the most frequently language in the detected location, wherein the determination is directly executed by the device or is indirectly executed by the device via an emergency management server communicating with the device.

3. The device of claim 1, wherein the emergency reporting message includes at least one of the detected location, a pre-stored personal information of a user of the device, and a pre-stored emergency reporting contact number.

4. The device of claim 1, wherein the transmission management unit is further configured to determine whether a text message is able to be sent using the emergency reporting contact number, and, upon determination that the text message is not able to be sent using the emergency reporting contact number, to trigger a voice call using the emergency reporting contact number.

5. The device of claim 1, wherein the transmission management unit is further configured to transmit the version of the determined language to a preset emergency management server or a destination corresponding to a preset contact number.

6. An emergency reporting method comprising:
detecting a current location of a user based on a mobile device of the user;
generating an emergency reporting message to indicate an emergency in an event of the emergency;
determining a transmission language of the message based on the detected location;
translating the message to a version of the determined language;
selecting an emergency reporting contact number based on the detected location; and
transmitting the version of the determined language using the selected emergency reporting contact number.

7. The method of claim 6, wherein the determined language corresponds to the most frequently language in the detected location, wherein the determination is directly executed by the mobile device of the user or is indirectly executed by the device via an emergency management server communicating with the device.

8. The method of claim 6, wherein the emergency reporting message includes at least one of the detected location, a pre-stored personal information of a user of the device, and a pre-stored emergency reporting contact number.

9. The method of claim 6, further comprising:
determining whether a text message is able to be sent using the emergency reporting contact number; and,
upon determination that the text message is not able to be sent using the emergency reporting contact number, triggering a voice call using the emergency reporting contact number.

10. The method of claim 6, further comprising transmitting the version of the determined language to a preset emergency management server or a destination corresponding to a preset contact number.
